(19) United States
(12) Patent Application Publication
(10) Pub. No.: US 2002/0195396 A1
(43) Pub. Date: Dec. 26, 2002

(54) Agent for removing heavy metals comprising a sulphur compound

(76) Inventors: Jean-Yves Chane-Ching, Eaubonne (FR); Anne-Gaelle Dreno, Paris (FR); Jean-Claude Kiefer, Precy-sur-Oise (FR)

Correspondence Address: RHODIA INC., 259 Prospect Plains Road, Cranbury, NJ, 08512-7500, US

(21) Appl. No.: 10/150,448

(22) Filed: May 17, 2002

Related U.S. Application Data
(63) Continuation of application No. 09/066,346, filed on Nov. 9, 1998.

(30) Foreign Application Priority Data
Oct. 31, 1995 (FR) 95/12974

(51) Int. Cl. C02F 1/52

(52) U.S. Cl. 210/702

(57) ABSTRACT

An agent for removing heavy metals from an aqueous effluent, including at least one compound selected from a silicate or aluminosilicate compound such as an alkali-metal silicate or aluminosilicate, and a carbonate compound such as an alkali-metal carbonate; a sulphur compound; and optionally a carrier, particularly a clay carrier. The agent may also be used to stabilize such metals. Said agent is useful for removing or stabilizing heavy metals, including mercury, that are contained in the water used for scrubbing flue gases from waste incinerators, particularly for household refuse or industrial waste.

The present invention relates to an agent for removing heavy metals contained in a medium, in particular an aqueous effluent.

Waste incineration is subject to a rather strict regulatory framework.

Legislation in the field of heavy metal discharges to the natural environment is, in particular, changing very rapidly. Aqueous liquors from the scrubbing (or purification) of flue gases from plants for the incineration of household refuse or industrial waste, in particular of industrial effluents of the spent sulphuric acid typo, are media containing heavy metals. Likewise, certain soils are contaminated by the presence of such metals.

Thus, in the field of aqueous liquors for scrubbing flue gases from plants for the incineration of household refuse, the most well known process for removing heavy metals consists of a basic precipitation carried out with lime; the settling/separation stage which follows is generally improved by the incorporation of a flocculating agent.

However, this process exhibits a number of disadvantages.

In particular, a very large volume of sludge is generated by the precipitation with lime; this sludge, after filtration and compaction in the cake form, must currently be placed in special landfill sites.

Furthermore, the sludge composition obtained can be difficult to stabilize (or immobilize) by current techniques. The presence of a large amount of calcium in the sludge can greatly inhibit the stabilization (or immobilization) operations, such as, for example, stabilization by vitrification. Now, future regulations relating to the storage of final special waste make it necessary to stabilize (or immobilize) the cake before it can be allowed onto the storage site, in order to very substantially reduce the leaching of this type of waste.

Finally, the removal of heavy metals of the mercury type using conventional processes generally turns out to be difficult, indeed impossible.

The aim of the present invention is in particular to provide a means which makes possible an efficient removal (or uptake) of heavy metals, and in particular mercury, and which does not exhibit the abovementioned disadvantages.

To this end, the present invention provides a novel agent for removing (or taking up) heavy metals present in a medium, the said agent being a mixed product comprising (i) at least one compound of the silicate or aluminosilicate type and/or at least one compound of the carbonate type, (ii) at least one sulphur compound and, in general, (iii) at least one carrier, preferably a clay.

It also relates to the use of the said agent for removing heavy metals, in particular mercury, contained in a medium, in particular an aqueous effluent.

It also relates to an agent for stabilizing (or immobilizing) the said heavy metals comprising the said agent for removing heavy metals.

The Applicant Company has found, surprisingly, that the use of an agent for removing heavy metals as defined above, in particular when it comprises both a compound of the silicate or aluminosilicate type and a compound of the carbonate type, made possible very efficient removal of heavy metals from the medium containing them, including mercury, and, advantageously, an improvement in the sludge obtained/supernatant liquid settling and separation, a degree of improvement in the aptitude for stabilization of this sludge, that is to say a degree of improvement in the ability of the latter to withstand leaching, and a decrease in the residual calcium content in the precipitate with respect to what is obtained with the process with lime described above.

Thus, one of the subject-matters of the invention is an agent for removing (or taking up) heavy metals contained in a medium, characterized in that the said agent comprises:

at least one compound chosen from a compound of the silicate or aluminosilicate type, hereinafter known as compound (A), and a compound of the carbonate type, hereinafter known as compound (B),

at least one sulphur compound, hereinafter known as compound (C), and

optionally at least one carrier.

Heavy metals is understood to mean in particular metals with a valency greater than or equal to 2, preferably equal to 2, and in particular those chosen from antimony, arsenic, bismuth, cadmium, chromium, cobalt, copper, tin, manganese, mercury, molybdenum, nickel, gold, lead, thallium, tungsten, zinc, iron or metals from the actinide family.

The heavy metals particularly targeted by the present invention are chromium, copper, nickel, iron and, to a greater degree, cadmium, mercury, lead and zinc.

The agent according to the invention is advantageously used when the medium to be treated contains, as heavy metals, at least mercury.

The heavy metals to be removed are usually in the form of ions, in particular in the form of their respective cations (for example, Cr³⁺, CU²⁺, Ni²⁺, Fe²⁺, Fe³⁺, Cd²⁺, Hg²⁺, Pb²⁺ or Zn²⁺)

The medium to be treated is preferably liquid.

This medium can thus be composed of an aqueous effluent, in particular an aqueous industrial effluent (that is to say, an aqueous effluent originating from an industrial process).

This medium can be, for example, an aqueous effluent formed by the aqueous liquors from the scrubbing (or purification) of flue gases from the incineration of waste, in particular of household refuse, industrial waste or hospital waste, by aqueous liquors from washing solid material, such as earth, containing heavy metals or by aqueous surface treatment effluents.

The mixed product for removing heavy metals from a medium according to the invention, which can be used to purify the said medium, can be regarded, when it contains at least one carrier, as the composite product formed:

of at least one active principle (or precipitating agent) composed of:

at least one compound chosen from a compound (A) of the silicate or alumino-silicate type and one compound (B) of the carbonate type, and

at least one sulphur compound (C); and

of at least one carrier (or substrate), preferably composed of at least one clay.

According to a first alternative form, the agent according to the invention comprises:

at least one compound (A) of the silicate or aluminosilicate type,

at least one sulphur compound (C),

optionally at least one carrier.

According to a second alternative form, the agent according to the invention comprises:

at least one compound (B) of the carbonate type,

at least one sulphur compound (C), and

optionally at least one carrier.

According to a third alternative form, which is the preferred alternative form of the invention, the agent according to the invention comprises:

at least one compound (A) of the silicate or aluminosilicate type,

at least one compound (B) of the carbonate type,

at least one sulphur compound (C), and

optionally at least one carrier.

The compound (A) is preferably an alkali metal, in particular sodium or potassium, silicate or aluminosilicate.

The compound (A) is advantageously a sodium silicate, in particular in the case of the third alternative form of the invention. The said sodium silicate then generally exhibits an SiO₂/Na₂O molar ratio of between 0.5 and 3.8, for example equal to approximately 2.

The compound (B) is preferably an alkali metal carbonate or a carbonate hydroxide chosen from hydrotalcite and dawsonite.

Hydrotalcite is a basic magnesium aluminium carbonate. Dawsonite is a basic aluminium sodium carbonate.

The compound (B) is advantageously an alkali metal carbonate, preferably a sodium carbonate, in particular in the case of the third alternative form of the invention.

In the agent according to the third alternative form of the invention, the ratio by weight of the compound (B) to the compound (A) can vary within relatively broad ranges of values. Nevertheless, this compound (B)/compound (A) ratio by weight is generally between 0.5 and 4.0, preferably between 1.1 and 3.5, in particular between 1.5 and 2.5.

The carrier optionally contained in the agent according to the invention is preferably a clay.

The clay then contained in the agent according to the invention can be of natural or synthetic origin.

The clay thus employed in the agent according to the invention advantageously exhibits a high content by weight of Al₂O_{3;} this content is, for example, between 20 and 40%.

A clay of lamellar or phyllosilicate structure can be employed according to the invention.

It is thus possible to use a clay chosen from the group comprising kaolinites and serpentines.

The clay can also be chosen from the group comprising montmorillonites, bentonites (in particular alkaline bentonites), talc and mica.

The clay chosen preferably belongs to one of these two groups.

A clay of chlorite-type structure can optionally be employed.

The agent according to the invention generally contains, as clay, a montmorillonite or a bentonite.

The content of carrier, in particular of clay, in the agent according to the invention is usually between 5 and 90% by weight, for example between 10 and 35% by weight, with respect to the total weight of the said agent.

The presence or absence of a carrier, in particular of a clay, in the agent according to the invention depends essentially on the nature of the compound (C).

The compound (C) contained in the agent according to the invention can be an inorganic sulphur compound.

The agent according to the invention generally does not then contain a carrier, in particular a clay.

An inorganic sulphide, in particular a barium sulphide (BaS) or a strontium sulphide (SrS), or, preferably, an inorganic (poly)thiocarbonate, in particular an alkali metal (poly)thiocarbonate, for example potassium or sodium (poly)thiocarbonate, can be employed as inorganic sulphur compound. It is thus possible to use any salt of thiocarbonic acid, such as potassium thiocarbonate (K₂CS₃).

The compound (C) contained in the agent according to the invention is preferably an organic sulphur compound (or so-called organosulphur compound).

The agent according to the invention then preferably contains at least one carrier, in particular a clay.

An organothiophosphate or an organodithiophosphate, in particular an alkali metal, for example sodium, dialkyl or diaryl dithiophosphate, can be used as organic sulphur compound.

The alkali metal dialkyl or diaryl dithiophosphates which can be used correspond in particular to the following formula:

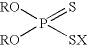

in which X is an alkali metal, for example sodium, and R is an aryl radical or, preferably, an alkyl radical, for example a methyl, ethyl, n-propyl, isopropyl, 1-methylpropyl or isobutyl radical.

A (poly)mercapto compound, in particular a mercapto, dimercapto or trimercapto compound, can preferably be employed as organic sulphur compound. This organic sulphur compound can then be a triazine (for example, an as-triazine or, preferably, an s-triazine) substituted by 1, 2 or 3 monovalent —SH radicals.

This organic sulphur compound is more particularly trimercapto-s-triazine, which corresponds to the following formula:

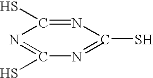

The sulphur compound (C) is preferably localized, in the carrier, at the core of the agent according to the invention.

This localization at the core of the nixed product according to the invention makes possible in particular a delayed dissolution of the sulphur compound (C) during use of the said mixed product in a liquid medium; the Applicant Company has found that the dissolution of the sulphur compound (C) takes place with a degree of delay with respect to the dissolutions of the constituents (A) of the silicate or aluminosilicate type and (B) of the carbonate type.

This delayed dissolution exhibits in particular the advantage of reducing the amount of sulphur compound needed in the agent according to the invention.

The mixed product formed by the agent according to the invention is usually provided in the form of granules (cogranules) or of a powder, the size of the grains of which is preferably between 0.1 and 2.0 mm, in particular between 0.2 and 1.6 mm.

The agent according to the invention generally exhibits a content by weight of free water (or moisture) of between 10 and 30%, preferably between 15 and 25%. This water content can be determined by measuring the loss in mass by calcination at 350° C. for 6 hours.

The content of sulphur compound (C) in the agent according to the invention can be between 0.01 and 5%, in particular between 0.1 and 4%, by weight; it is preferably between 0.4 and 3%, for example between 0.5 and 2%, by weight.

The agent according to the invention is prepared by any appropriate process which preferably allows the introduction of the sulphur compound at the core of this mixed product.

A particularly preferred process when it is desired to prepare an agent containing a carrier, such as a clay, will be described hereinbelow.

The sulphur compound (C) is first incorporated at the core of the carrier.

For this, an aqueous solution of the sulphur compound (C) is added, generally with agitation, to a carrier, in particular a clay, introduced beforehand into a granulator, preferably a mixer/granulator. The granulation can be carried out using a disc granulator or a granulator of Lodige type.

The granulation is subsequently completed by fluid bed drying, preferably at a temperature of between 40 and 100° C., generally at a value kept constant for a certain period of time after a temperature rise. This temperature can be between 40 and 70° C., for example between 45 and 55° C. It can also be between 70 and 100° C., in particular between 85 and 95° C.

The delayed dissolution of the sulphur compound (C) during use of the agent according to the invention in a liquid medium is also due, in general, to this heat treatment. The temperature of the heat treatment can constitute a means of controlling the kinetics of dissolution of the sulphur compound (C).

The dried product obtained, in the form of granules, can subsequently be milled (in order in particular to achieve decaking of the said granules) and, optionally, sieved (with, for example, recovery solely of the fraction of the granules with a size of less than 400 μm, indeed than 200 μm).

Following this incorporation of the sulphur compound (C) at the core of the carrier, the compounds (A) and/or (B) must be added, this advantageously being carried out by the following preferred methods.

In the case where it is desired to prepare an agent according to the first alternative form of the invention, that is to say an agent containing a compound (A) and also comprising a carrier, the product obtained previously (carrier+sulphur compound (C)) is mixed with an aqueous solution of the compound (A).

This mixing is preferably carried out by spraying, for example at a spray pressure of between 5 and 15 bar, an aqueous solution of the compound (A) onto the said product obtained previously, introduced beforehand into a granulator (for example that used above), preferably a mixer/granulator, and generally with agitation. The granulation can be carried out using a disc granulator or a granulator of Lodige type. The aqueous solution of the compound (A), the pH of which is usually between 10 and 14, is generally heated beforehand, in particular to a temperature of between 60 and 90° C., for example between 70 and 85° C.

If the compound (A) is a sodium silicate, use is generally made of an aqueous sodium silicate solution exhibiting an SiO₂/Na₂O molar ratio of between 0.5 and 3.8 and a silicate concentration, expressed as SiO₂, of between 0.1 and 10 mol/l, for example between 0.2 and 8 mol/l.

This mixing stage (in particular spraying) can be followed by fluid bed drying under conditions such as indicated above (but generally at a lower temperature (for example between 30 and 40° C.)) and then by further mixing with an aqueous solution of the compound (A), which mixing preferably consists in spraying the said solution onto the product resulting from the latter fluid bed drying, introduced beforehand into a granulator, preferably a mixer/granulator (for example that used above), under conditions such as mentioned above.

A final sieving stage can be employed depending on the desired particle size.

In the case where it is desired to prepare an agent according to the second alternative form of the invention, that is to say an agent containing a compound (B) and also comprising a carrier, the preparation can be carried out as indicated above for the first alternative form, an aqueous solution of the compound (B) being used instead of an aqueous solution of the compound (A); if the compound (B) is a sodium carbonate, use is then generally made of an aqueous sodium carbonate solution with a carbonate concentration, expressed as Na₂CO₃, of between 0.1 and 4 mol/l, for example between 0.2 and 3 mol/l.

It is also possible to add, generally with agitation, the product obtained (carrier+sulphur compound (C)) and solid compound (B) to a granulator (for example that used previously), preferably a mixer/granulator, and to spray an aqueous solution of the compound (B), for example as defined above, onto the mixture in the granulator, in particular at a spray pressure of between 5 and 15 bar. The granulation can be carried out using a disc granulator or a granulator of Lodige type.

This granulation can optionally be followed by fluid bed drying, under conditions such as indicated above (but generally at a lower temperature (for example between 30 and 40° C.)).

A final sieving stage can be carried out depending on the desired particle size.

In the case where it is desired to prepare an agent according to the third alternative form of the invention, that is to say an agent containing a compound (A) and a compound (B) and also comprising a carrier, several embodiments are possible.

According to a first embodiment, the product obtained above (carrier+sulphur compound (C)) is mixed with an aqueous solution of the compound (A) (respectively (B)) or with an aqueous solution of the compound (A) and of the compound (B), preferably by spraying, in particular at a spray pressure of between 5 and 15 bar, the said solution onto the said product, introduced beforehand into a granulator (for example that used previously), preferably a mixer/granulator, and generally with agitation; the granulation can be carried out using a disc granulator or a granulator of Lodige type.

This mixing stage (in particular spraying) can be followed by fluid bed drying under conditions such as indicated above (but generally at a lower temperature (for example between 30 and 40° C.)) and then by mixing with an aqueous solution of the compound (B) (respectively (A)) or with an aqueous solution of the compound (A) and of the compound (B), which mixing preferably consists in spraying the said solution onto the product resulting from the latter fluid bed drying, introduced beforehand into a granulator (for example that used previously), preferably a mixer/granulator, under conditions such as described above.

According to a second, highly preferred embodiment, the product obtained (carrier+sulphur compound (C)) and solid compound (B) are added, generally with agitation, to a granulator (for example that used previously), preferably a mixer/granulator, and an aqueous solution of the compound (A) is sprayed onto the mixture (generally with agitation) in the granulator, in particular at a spray pressure of between 5 and 15 bar; the granulation can be carried out using a disc granulator or a granulator of Lodige type. The aqueous solution of the compound (A), the pH of which is usually between 10 and 14, is generally heated beforehand, in particular to a temperature of between 60 and 90° C., for example between 70 and 85° C.

Likewise, if the compound (A) is a sodium silicate, use is generally made of an aqueous sodium silicate solution such as defined previously.

This mixing stage (in particular spraying) is preferably followed by fluid bed drying, such as mentioned previously (but generally at a lower temperature (for example between 30 and 40° C.)) and then by further mixing with an aqueous solution of the compound (A), which mixing advantageously consists in spraying the said solution onto the product resulting from the latter fluid bed drying, introduced beforehand into a granulator (for example that used previously), preferably a mixer/granulator, under conditions such as described above.

A final sieving stage can be employed depending on the desired particle size.

It should be noted that the addition of the compounds (A) and/or (B), following the incorporation of the sulphur compound (C) at the core of the carrier, can optionally be carried out by the following (non-preferred) method: either an aqueous solution of the compound (A) (in the case of the agent according to the first alternative form of the invention) or an aqueous solution of the compound (B) (in the case of the agent according to the second alternative form of the invention) or a mixture of an aqueous solution of the compound (A) and of an aqueous solution of the compound (B) (in the case of an agent according to the third alternative form of the invention) is added to the product obtained previously (carrier+sulphur compound (C)), introduced beforehand into a reactor subjected to agitation; a solution is thus obtained; granules are then prepared by atomizing this solution at a temperature, for example, of between 40 and 500° C.; to this end, use may be made of any type of suitable atomizer, in particular an atomizer of the Buchi type or a rotary, nozzle, liquid-pressure or twin-fluid atomizer.

When it is desired to prepare an agent not containing a carrier, in particular clay, it is possible to employ a process identical to the preferred process described above for the agent containing a carrier, the stage of incorporation of the sulphur compound (C) at the core of the carrier being omitted and the support+sulphur compound (C) product being replaced in the above account by sulphur compound (C).

The use of at least one agent according to the invention to remove heavy metals from a medium containing them, in particular from a liquid effluent (or solution), in particular from an aqueous effluent (or solution), can be carried out in the following way.

The agent according to the invention is introduced with stirring into the liquid effluent to be treated. The final pH of the suspension containing the said agent which has been added thereto is preferably between 7 and 11 or adjusted to a value of between 7 and 11 by prior addition of a base or of an acid; the said pH can be in particular (adjusted) to about 8. The final pH depends on the amount of agent according to the invention introduced into the liquid effluent to be treated and on the starting pH of the said effluent. Stirring is continued, for example for 5 to 60 minutes. The suspension can subsequently be allowed to stand (settle) at ambient temperature for a certain period of time, generally between 0.5 and 24 hours, in particular between 0.5 and 6 hours. The settling time can be reduced if use is made of rapid settling methods known to a person skilled in the art. The precipitate formed, that is to say the agent according to the invention laden with heavy metals, in particular with mercury, is then separated by settling, filtering and/or centrifuging the suspension.

The medium to be treated, in particular when it consists of a liquid effluent (in particular an aqueous effluent (a solution)), generally contains 0.5 to 6000 mg/l, for example 1 to 1000 mg/l, in particular 2 to 300 mg/l, of heavy metals.

The amount of agent according to the invention added to the medium to be treated is such that the (SiO₂+CO₃²⁻)/(cations present in the medium to be treated) molar ratio is generally between 0.7 and 2.5, for example between 1.0 and 2.2, in particular between 1.1 and 1.9. Cations present in the medium to be treated is understood here to mean heavy metal cations and Ca²⁺ cations.

The use of the agents according to the invention advantageously makes possible very efficient removal of heavy metals, in particular mercury, in particular in a fairly broad range of pH values, generally between 7 and 11.

Furthermore, it is found that, after separation, the precipitate formed, that is to say the agent according to the invention laden with heavy metals, preferably exhibits a satisfactory aptitude for stabilization (or immobilization). Its behaviour with respect to leaching is very acceptable: this is because it can be leached only to a very slight extent, that is to say that it releases virtually no or very few heavy metal cations which it contains when it is in the presence of water; the amounts of heavy metal chemical components in leachates obtained from leaching tests carried out conventionally are relatively low.

Thus, another subject-matter of the invention consists of an agent for stabilizing (or immobilizing) heavy metals contained in a medium, characterized in that it comprises at least one agent as described above.

If the presence of a carrier in the agent according to the invention generally makes possible a localized precipitation around the said carrier, it also makes it possible, in particular in the case of clay, to promote, surprisingly, in the case where the agent according to the invention comprises a compound of the carbonate type, the settling, in particular to increase the rate of settling. Likewise, it can also make it possible to decrease the low contents of heavy metals in the leachates such as mentioned above. It is particularly advantageous when the agent is used especially for finishing, that is to say for removing the final traces of heavy metals.

The following examples illustrate the invention without, however, limiting the scope thereof.

### EXAMPLE 1

1) 7.5 kg of bentonite clay, sold by the company Comptoir de Minèraux et Matières Premières under the reference Absoclay SPV, are introduced into a Lodige mixer/granulator with a capacity of 20 liters.

After starting to rotate the blades at 100 revolutions/min, 1800 ml of a 15% by weight aqueous solution of trimercapto-s-triazine (sold by the company Dègussa under the reference TNT 15), with a relative density equal to 1.12 (trimercapto-s-triazine in the sodium salt form, with a molar mass equal to 243.22 g), are introduced therein over 7 minutes.

Granules with a moisture content of 23.4% are recovered.

This mass of granules is separated into two equal parts, each of them subsequently being independently dried by passing into a fluid bed (carrying the reference Glatt GPCG3).

2) During the fluid bed drying, the first part of the granules is subjected to a temperature rise to 50° C.; the temperature is subsequently maintained at this stationary level of 50° C. for 10 minutes, the fluidization flow being fixed at approximately 200 m³/h.

The final moisture content of the granules thus dried is 3%.

These granules are subsequently milled using a Forplex mill and then sieved, on conclusion of which the fraction of granules with a size of less than 200 μm is recovered.

3) 2.5 kg of the said granules recovered above (on conclusion of 2)) and 4.875 kg of Na₂CO₃ in the powder form are introduced into a Lodige mixer/granulator with a capacity of 20 liters; homogenization of the granules and powder is carried out at 167 revolutions/min for 15 minutes.

4.2 kg of a sodium silicate solution, heated beforehand to 75° C., with an SiO₂/Na₂O molar ratio equal to 2 and with a silicate concentration, expressed as SiO₂, of 30.6% by weight are subsequently sprayed, at a spray pressure of 10 bar, onto the mixture in the mixer/granulator operating at the same speed (167 revolutions/min).

Granules are recovered (with a moisture content of 17.9%) which are then dried by passing into a fluid bed (carrying the reference Glatt GPCG3) under the conditions shown in 2), except that the temperature is 35° C.

The moisture content of the granules thus dried is 12%.

Finally, 1.650 kg of a sodium silicate solution as defined above are sprayed onto these granules, reintroduced beforehand into the restarted mixer/granulator (i.e., in the combined two sprayings, 2.650 kg of dry sodium silicate).

The granules obtained exhibit a moisture content of 19%.

The granules having a size of between 0.2 and 1.6 mm are recovered by sieving.

The product obtained (P1) formed by the said granules comprises approximately 49% of sodium carbonate, 26% of sodium silicate, 24% of bentonite clay and 1% of trimercapto-s-triazine.

### EXAMPLE 2

1) 2) During the fluid bed drying, the second part of the granules (obtained in part 1) of Example 1) is subjected to a temperature rise to 90° C.; the temperature is subsequently maintained at this stationary level of 90° C. for 10 minutes, the fluidization flow being fixed at approximately 200 m³/h.

The final moisture content of the granules thus dried is 3%.

These granules are subsequently milled using a Forplex mill and then sieved, on conclusion of which the fraction of granules with a size of less than 200 μm is recovered.

3) 2.5 kg of the said granules recovered above (on conclusion of 2)) and 4.875 kg of Na₂CO₃ in the powder form are introduced into a Lodige mixer/granulator with a capacity of 20 liters; homogenization of the granules and powder is carried out at 167 revolutions/min for 15 minutes.

4.2 kg of a sodium silicate solution, heated beforehand to 75° C., with an SiO₂/Na₂O molar ratio equal to 2 and with a silicate concentration, expressed as SiO₂, of 30.6% by weight are subsequently sprayed, at a spray pressure of 10 bar, onto the mixture in the mixer/granulator operating at the same speed (167 revolutions/min).

Granules are recovered (with a moisture content of 17.9%) which are then dried by passing into a fluid bed (carrying the reference Glatt GPCG3) under the conditions shown in 2), except that the temperature is 35° C.

The moisture content of the granules thus dried is 12%.

Finally, 1.650 kg of a sodium silicate solution as defined above are sprayed onto these granules, reintroduced beforehand into the restarted mixer/granulator (i.e., in the combined two sprayings, 2.650 kg of dry sodium silicate).

The granules obtained exhibit a moisture content of 18%.

The granules having a size of between 0.2 and 1.6 mm are recovered by sieving.

The product obtained (P2) formed by the said granules comprises approximately 49% of sodium carbonate, 26% of sodium silicate, 24% of bentonite clay and 1% of trimercapto-s-triazine.

### EXAMPLE 3

An aqueous effluent of aqueous liquors from the scrubbing of flue gases from the incineration of household refuse is reconstituted as follows.

The following amounts are dissolved in 5 liters of aqueous sodium chloride solution containing 200 g of NaCl:

| | | | |
|---|---|---|---|
| Na₂SO₄ | 7.390 g | CuCl₂ | 0.067 g |
| CaCl₂.2H₂O | 18.370 g | CdCl₂ | 0.041 g |
| AlCl₃.6H₂O | 2.235 g | ZnCl₂ | 1.574 g |
| FeCl₃.6H₂O | 1.219 g | PbCl₂ | 0.067 g |
| NiCl₂ | 0.102 g | HgCl₂ | 0.070 g |

The pH of this effluent is adjusted to a value of 2 by addition of hydrochloric acid.

The said effluent exhibits the following contents, expressed in mg/l:

| | | | |
|---|---|---|---|
| Ca²⁺ | 1000 | Cu²⁺ | 5 |
| Al³⁺ | 50 | Cd²⁺ | 5 |
| Fe²⁺ + Fe³⁺ | 50 | Zn²⁺ | 150 |
| Ni²⁺ | 5 | Pb²⁺ | 10 |
| | | Hg²⁺ | 10 |

Four tests on the removal of the heavy metals contained in this effluent are carried out: each of the products P1 and P2 prepared in Examples 1 and 2 is employed (separately) for final neutralization pH values of 8 and 9.

The amounts of product P1 and P2 to be used per 500 ml of the said effluent are as follows:

| | |
|---|---|
| P1 | 3.00 g for a final pH of 8, |
| | 4.34 g for a final pH of 9, |
| P2 | 3.33 g for a final pH of 8, |
| | 4.35 g for a final pH of 9. |

For each test, the amount of product P1 (or P2) indicated above is introduced instantaneously, with stirring, into 500 ml of the said effluent, and stirring is maintained for 30 minutes.

The suspension obtained is subsequently left standing at ambient temperature for 4 hours.

It is then centrifuged at 3000 revolutions/min for 10 minutes.

The following concentrations (Table 1) of various components of the purified effluent (that is to say, the supernatant part) are measured by any appropriate method (in particular ICP/MS (plasma emission spectroscopy with mass detection (equipment used: Elan 5000, Perkin-Elmer)) for the elements Hg, Cd and Pb and ICP/OES (plasma emission spectroscopy with optical detection (equipment used: Sopra DPS 1500)) for the elements Ca, Al, Fe, Ni, Cu and Zn).

TABLE 1

| | | Content after | | Content after | |
|---|---|---|---|---|---|
| | | treatment with P1 | | treatment with P2 | |
| | Starting | (mg/l) | | (mg/l) | |
| | content | Final | Final | Final | Final |
| Component | (mg/l) | pH:8 | pH:9 | pH:8 | pH:9 |
| Ca²⁺ | 1000 | 445 | 29 | 365 | 26 |
| Al³⁺ | 50 | <0.2 | <0.2 | <0.2 | <0.2 |
| Fe²⁺ + Fe³⁺ | 50 | <0.1 | <0.1 | <0.1 | <0.1 |
| Ni²⁺ | 5 | 1.2 | 0.2 | 0.5 | 0.4 |
| Cu²⁺ | 5 | <0.2 | <0.2 | <0.2 | <0.2 |
| Cd²⁺ | 5 | 0.07 | 0.20 | 0.06 | 0.40 |
| Zn²⁺ | 150 | <0.3 | <0.3 | <0.3 | <0.3 |
| Pb²⁺ | 10 | <0.05 | 0.05 | <0.05 | 0.11 |
| Hg²⁺ | 10 | <0.02 | 0.05 | 0.02 | 0.07 |

### EXAMPLE 4

1) 3.5 kg of Na₂CO₃ and 100 g of barium sulphide are introduced into a Lodigo mixer/granulator with a capacity of 20 liters; homogenization of the mixture is carried out at 160 revolutions/min for 20 minutes.

4.0 kg of a sodium silicate solution, heated beforehand to 75° C., with an SiO₂/Na₂O molar ratio equal to 2 and with a silicate concentration, expressed as SiO₂, of 30.6% by weight are subsequently sprayed, at a spray pressure of 12 bar, onto the mixture in the mixer/granulator operating at the same speed (160 revolutions/min).

Granules are recovered which are then dried, for 45 minutes, in a rotary dryer using hot air, such that the temperature of the granules does not exceed 50° C.

The granules are subsequently sieved (using a 1.6 mm sieve); the reject is milled using a Forplex pin mill equipped with a 3 mm screen. The sieved granules and the milled granules are reintroduced into the mixer/granulator.

Finally, 2.4 kg of a sodium silicate solution as defined above are sprayed onto these granules in the restarted mixer/granulator (i.e., in the combined two sprayings, 2.9 kg of dry sodium silicate).

The granules obtained are then dried as indicated above.

The granules having a size of between 0.2 and 1.6 mm are subsequently recovered by sieving.

The product obtained (P3) formed by the said granules comprises approximately 54% of sodium carbonate, 44.5% of sodium silicate and 1.5% of barium sulphide.

1. Agent for removing heavy metals contained in a medium, characterized in that the said agent comprises:
at least one compound chosen from a compound (A) of the silicate or aluminosilicate type and a compound (B) of the carbonate type,
at least one sulphur compound (C),
optionally at least one carrier.

2. Agent according to claim 1, characterized in that the said compound (A) is an alkali metal, in particular sodium or potassium, silicate or aluminosilicate.

3. Agent according to claim 2, characterized in that the said compound (A) is a sodium silicate.

4. Agent according to one of claims 1 to 3, characterized in that the said compound (B) is a carbonate hydroxide chosen from hydrotalcite and dawsonite.

5. Agent according to one of claims 1 to 3, characterized in that the said compound (B) is an alkali metal carbonate, in particular a sodium carbonate.

6. Agent according to one of claims 1 to 5, characterized in that it comprises:
at least one compound (A) of the silicate or aluminosilicate type,
at least one sulphur compound (C),
optionally at least one carrier.

7. Agent according to one of claims 1 to 5, characterized in that it comprises:
at least one compound (B) of the carbonate type,
at least one sulphur compound (C),
optionally at least one carrier.

8. Agent according to one of claims 1 to 5, characterized in that it comprises:
at least one compound (A) of the silicate or aluminosilicate type,
at least one compound (B) of the carbonate type,
at least one sulphur compound (C), and
optionally at least one carrier.

9. Agent according to claim 8, characterized in that the said compound (A) is a sodium silicate and the said compound (B) is a sodium carbonate.

10. Agent according to either of claims 8 and 9, characterized in that the compound (B)/compound (A) ratio by weight is between 0.5 and 4.0, preferably between 1.1 and 3.5.

11. Agent according to one of claims 1 to 10, characterized in that the said compound (C) is an inorganic sulphur compound.

12. Agent according to claim 11, characterized in that the sulphur compound (C) is an inorganic sulphide, in particular a barium sulphide or strontium sulphide, or an inorganic (poly)thiocarbonate.

13. Agent according to one of claims 1 to 10, characterized in that the said compound (C) is an organic sulphur compound.

14. Agent according to claim 13, characterized in that the sulphur compound (C) is an organothiophosphate or an organodithiophosphate, in particular an alkali metal dialkyl or diaryl dithiophosphate.

15. Agent according to claim 13, characterized in that the sulphur compound (C) is a (poly)mercapto compound.

16. Agent according to claim 15, characterized in that the said sulphur compound (C) is a triazine, in particular an s-triazine, substituted by 1, 2 or 3 monovalent —SH radicals.

17. Agent according to claim 16, characterized in that the said sulphur compound (C) is trimercapto-s-triazine.

18. Agent according to one of claims 13 to 17, characterized in that it comprises at least one carrier.

19. Agent according to one of claims 1 to 18, characterized in that it exhibits a content of sulphur compound (C) of between 0.01 and 5%, in particular between 0.1 and 4%, by weight.

20. Agent according to one of claims 1 to 19, characterized in that the said carrier is a clay.

21. Agent according to claim 20, characterized in that the said clay is a montmorillonite or a bentonite.

22. Agent according to one of claims 1 to 21, characterized in that it exhibits a content of carrier of between 5 and 90% by weight, in particular between 10 and 35% by weight.

23. Agent for stabilizing heavy metals contained in a medium, characterized in that it comprises at least one agent according to one of claims 1 to 22.

24. Use of at least one agent according to one of claims 1 to 22 for removing heavy metals contained in a medium.

25. Use according to claim 24, characterized in that the said heavy metals are chosen from cadmium, chromium, copper, mercury, nickel, lead, zinc and iron.

26. Use according to either of claims 24 and 25, characterized in that the said medium contains at least mercury.

27. Use according to one of claims 24 to 26, characterized in that the said medium is an aqueous effluent, in particular an aqueous industrial effluent.

28. Use according to claim 27, characterized in that the said medium is an aqueous effluent formed by aqueous liquors from the scrubbing of flue gases from the incineration of waste.
